(19) United States
(12) Patent Application Publication
(10) Pub. No.: US 2024/0356274 A1
(43) Pub. Date: Oct. 24, 2024

(54) MICRO-VIBRATION TERMINAL, PLUG-IN STRUCTURE, AND MOTOR VEHICLE

(71) Applicant: Changchun Jetty Automotive Technology Co., Ltd., Changchun, Jilin Province (CN)

(72) Inventors: Chao WANG, Changchun (CN); Chuan LIU, Changchun (CN)

(21) Appl. No.: 18/683,495

(22) PCT Filed: Aug. 15, 2022
(86) PCT No.: PCT/CN2022/112464

§ 371 Date: Feb. 13, 2024

(30) Foreign Application Priority Data
Aug. 17, 2021 (CN) 202110945331.2

(51) Int. Cl. H01R 13/533; H01R 13/03; H01R 13/11

(52) U.S. Cl. CPC H01R 13/533; H01R 13/03; H01R 13/11; H01R 2201/26

(57) ABSTRACT

The present disclosure provides a micro-vibration terminal, a plug-in structure and a motor vehicle, the micro-vibration terminal including a terminal fixing portion, a vibration body and a connection arm all of which are disposed sequentially, and the vibration body is fixedly connected to the terminal fixing portion, the terminal fixing portion is used for being electrically connected to a cable; the connection arm includes an overhanging end and a fixed end, the fixed end is fixedly connected to the vibration body, the overhanging end is used for being in contact fit with a mating plug-in terminal; and the vibration body is provided with a recess. Through the present disclosure, it is able to alleviate the technical problem that a contact area of a plug-in terminal is easy oxidized, and a service life of the plug-in terminal is shortened.

### RELATED APPLICATION

The present disclosure claims priority to Chinese Patent Application No. 202110945331.2, filed on Aug. 17, 2021 and entitled “MICRO-VIBRATION TERMINAL, PLUG-IN STRUCTURE, AND MOTOR VEHICLE”.

### TECHNICAL FIELD

The present disclosure relates to the technical field of electrical connection elements, particularly to a micro-vibration terminal, a plug-in structure, and a motor vehicle.

### BACKGROUND

In electrical connections, wire harnesses are used to conduct current and transmit signals. A terminal of the wire harness is provided with a plug-in terminal that may achieve a plugging connection with a corresponding conductive element. After the plug-in terminal is used for a period of time, sometimes there will be an oxide layer in its contact area, the oxide layer may reduce the conductive performance of the plug-in terminal: if it is not treated in time, the oxide layer will gradually corrode, making the plug-in terminal lose a conductive connection function.

A size of the plug-in terminal is generally small, and the contact area of the plug-in terminal is generally located at an inner side thereof, which makes an oxide layer on the contact area be difficult to treat: and the number of plug-in terminals in a device such as an automobile is large, which further increases the difficulty of cleaning. Currently, it is difficult to achieve regular treatment of the oxide layer of the plug-in terminal, and the appearance of the oxide layer shortens a service life of the plug-in terminal, and even will lead to connection failure to cause ignition and burning of a wire harness.

Therefore, in the technical field of electrical connection elements, a plug-in terminal with a longer service life is urgently needed to alleviate that a contact area of the plug-in terminal is easy to produce oxidation during plugging.

### SUMMARY

A purpose of the present disclosure is to provide a micro-vibration terminal, a plug-in structure and a motor vehicle, to alleviate a technical problem that a contact area of a plug-in terminal is easy oxidized, which shortens a service life of the plug-in terminal.

The purpose of the present disclosure may be realized by using the following technical solutions:

The present disclosure provides a micro-vibration terminal, including a terminal fixing portion, a vibration body and a connection arm all of which are disposed sequentially, and the vibration body is fixedly connected to the terminal fixing portion, the terminal fixing portion is used for being electrically connected to a cable: the connection arm includes an overhanging end and a fixed end, the fixed end is fixedly connected to the vibration body, the overhanging end is used for being in contact fit with a mating plug-in terminal: and the vibration body is provided with a recess.

The present disclosure provides a plug-in structure, including the aforementioned micro-vibration terminal, and further including a mating plug-in terminal, a plurality of micro-vibration terminals are connected through the terminal fixing portion, and the mating plug-in terminal are plugged with the plurality of the micro-vibration terminals.

The present disclosure provides a motor vehicle, including the aforementioned micro-vibration terminal.

The present disclosure provides a motor vehicle, including the aforementioned plug-in structure.

The present disclosure has the following characteristics and advantages:

The connection arm is in contact with the mating plug-in terminal, the vibration body is capable of vibrating with vibration of an equipment, the vibration body drives the connection arm to vibrate together, resulting in a relative motion between the connection arm and the mating plug-in terminal and resulting in repeated friction. Through the friction, an oxidation layer on a surface of the contact area between the mating plug-in terminal and the connection arm is removed, and oxidation corrosion of the micro-vibration terminal and the mating plug-in terminal is reduced. The vibration body is provided with a recess, which may reduce a stress, absorb energy during vibration, enhance an elastic deformation capacity of the vibration body, improve an effect of removing an oxidation layer by the friction, and avoid the fretting corrosion problem caused by a displacement of the connection arm due to vibration. The micro-vibration terminal is applied in the field of electrical connection, which may automatically remove an oxidation layer on a surface of a terminal, reduce oxidation corrosion and prolong a service life.

### BRIEF DESCRIPTION OF DRAWINGS

The following drawings are intended only to schematically illustrate and explain the present disclosure and do not limit the scope of the present disclosure, in the drawings:

FIGS. 1 to 11 are front views of the micro-vibration terminal according to the present disclosure:

FIG. 12 is an axonometric diagram of an embodiment of the micro-vibration terminal according to the present disclosure.

### DESCRIPTION OF EMBODIMENTS

In order to have a clearer understanding on the technical features, purpose and effect

of the present disclosure, now the specific embodiments of the present disclosure are illustrated with reference to the drawings. In the description of the present disclosure, unless otherwise explained, “a plurality of” means two or more.

### Solution 1

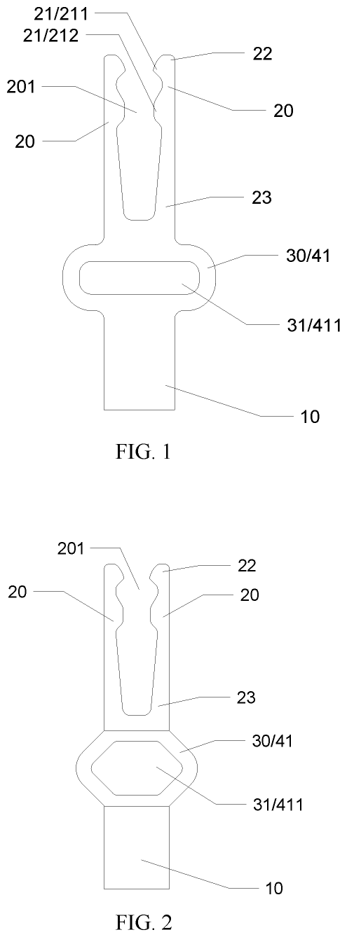

The present disclosure provides a micro-vibration terminal, as shown in FIGS. 1, 2 and 12, including a terminal fixing portion 10, a vibration body 30 and a connection arm 20 all of which are disposed sequentially. The vibration body 30 is fixedly connected to the terminal fixing portion 10, and the terminal fixing portion 10 is used for being electrically connected to a cable. The connection arm 20 includes an overhanging end 22 and a fixed end 23, the fixed end 23 is fixedly connected to the vibration body 30, and the overhanging end 22 is used for being in contact fit with a mating plug-in terminal. The vibration body 30 is provided with a recess 31.

The micro-vibration terminal is applied to an equipment such as an automobile, etc., the overhanging end 22 is in contact with a mating plug-in terminal, the vibration body 30 is capable of vibrating with vibration of an equipment, the vibration body 30 drives the connection arm 20 to vibrate together, resulting in a relative motion between the overhanging end 22 and the mating plug-in terminal and resulting in repeated friction. Through the friction, an oxidation layer on a surface of the contact area between the mating plug-in terminal and the overhanging end 22 is removed, and a risk of oxidation corrosion of the micro-vibration terminal and the mating plug-in terminal is reduced. The vibration body 30 is provided with the recess 31, which may reduce a stress, absorb energy during vibration, enhance an elastic deformation capacity of the vibration body 30, improve an effect of removing an oxidation layer by the friction, and avoid the fretting corrosion problem caused by a displacement of the connection arm 20 due to vibration. The micro-vibration terminal is applied in the field of electrical connection, which may automatically remove an oxidation layer on a surface of a terminal, reduce oxidation corrosion and prolong a service life.

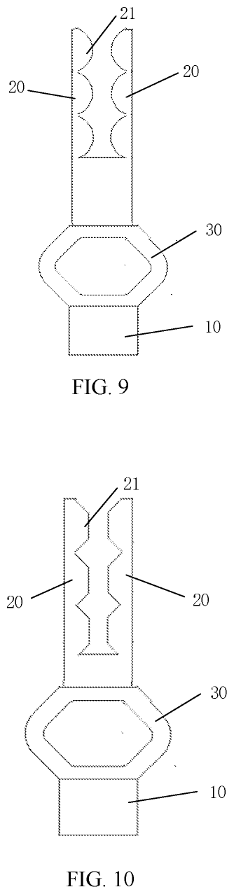

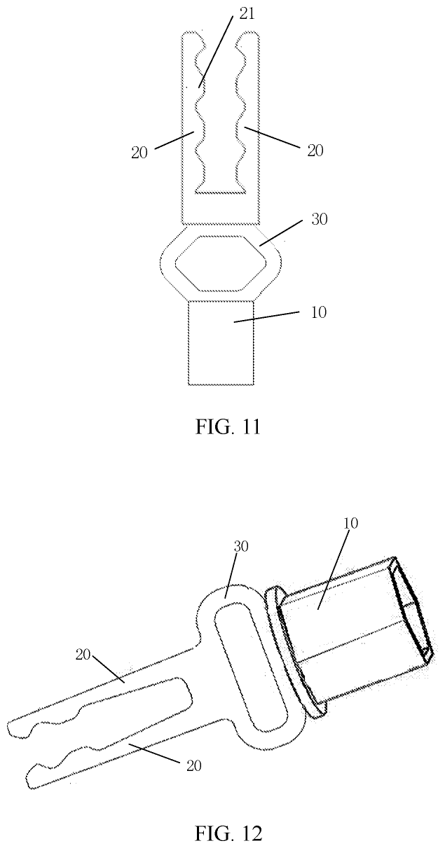

The micro-vibration terminal includes the at least two connection arms 20, a fixed end 23 of each of the connection arms 20 is fixedly connected to the vibration body 30, a plugging groove 201 is provided between two opposite overhanging ends 22, the mating plug-in terminal is capable of being plugged into the plugging groove 201 and in contact fit with the overhanging ends 22, so that realizes an electric connection with the connection arm 20. By clamping the mating plug-in terminal through the overhanging end 22, the mating plug-in terminal and the micro-vibration terminal are fixed together, and there is a larger contact area between them to ensure the reliability of the electrical connection. By adjusting a size or shape of the overhanging end 22, a clamping force is controlled to easily adapt to the mating plug-in terminal and meet various plugging requirements. As shown in FIGS. 1 to 11, the micro-vibration terminal includes two connection arms 20, a plugging groove 201 is formed between the two connection arms 20, and the mating plug-in terminal is capable of being plugged into the plugging groove 201. The number of the connection arms 20 in the micro-vibration terminal may be three or more, the micro-vibration terminal includes a plurality of plugging grooves 201, a plurality of mating plug-in terminals are plugged into each plugging groove 201 respectively, so that the plurality of mating plug-in terminals are in plug-in fitting with the micro-vibration terminal simultaneously.

In an embodiment, an inner side of the connection arm 20 is provided with a plurality of protrusion portions 21 distributed at intervals in an extension direction of the overhanging end 22. When the mating plug-in terminal is in plug-in fitting with the overhanging end 22, a top face of the protrusion portion 21 abuts against the mating plug-in terminal, the overhanging end 22 is more tightly connected with the mating plug-in terminal, which improves the reliability of mechanical connection and electrical connection between the mating plug-in terminal and the micro-vibration terminal and helps to remove an oxidation layer on the mating plug-in terminal when the connection arm 20 vibrates.

The protrusion portion 21 may be a strip extending in a thickness direction of the micro-vibration terminal. Further, a cross-section of the protrusion portion 21, as shown in FIGS. 8-11, is triangular, arc-shaped, trapezoidal or corrugated, respectively.

As shown in FIG. 1, a plurality of protrusion portions 21 include a first protrusion portion 211 which is triangular, and when the connection arm 20 moves relative to the mating plug-in terminal, the first protrusion portion 211 scratches an oxidation layer on the surface of the mating plug-in terminal, which enhances a scraping effect.

As shown in FIG. 1, a plurality of protrusion portions 21 include a second protrusion portion 212 which is trapezoidal, the contact area between the second protrusion portion 212 and the mating plug-in terminal is larger, which ensures the conductive performance and at the same time improves an effect of removing the oxidation layer through friction. The second protrusion portion 212 may also be arc-shaped or corrugated.

Further, cross-section shapes of the plurality of protrusion portions 21 of the same overhanging end 22 are different, the plurality of protrusion portions 21 are work together so that the conductive performance is better, and meanwhile, an effect of removing the oxidation layer is improved, an oxidation situation is reduced, and a service life of the micro-vibration terminal and of the mating plug-in terminal is prolonged.

The vibration body 30 has a solid body which is usually a metal structure. The recess 31 is a non-solid body and may be a hole or groove. The recess 31 is located in a region between the connection arm 20 and the terminal fixing portion 10, and is provided at a side of or in the middle of the solid body of vibration body 30. The vibration body 30 is provided with the recess 31, which may reduce a stress, absorb energy during vibration and enhance an elastic deformation capacity of the vibration body 30.

In an embodiment, the vibration body 30 is a ring-shaped body, as shown in FIGS. 1 and 2, the recess 31 is a central hole 411 of the ring-shaped body 41. The vibration body 30 is provided with the central hole 411 which is a through-hole, a side edge of the through-hole has better elasticity. When a vehicle body moves, the vibration body 30 vibrates slightly to remove an oxidation layer on a contact area: the vibration body 30 may also adapt to a position deviation caused by vibration and different assembly tolerances.

The ring-shaped body and the central hole are polygonal, circular or ellipse-shaped. Further, as shown in FIG. 1, the ring-shaped body 41 is rectangular, and the central hole 411 is a rectangular hole. As shown in FIG. 2, the ring-shaped body 41 is hexagonal, and the central hole 411 is a hexagonal hole. Exemplarily, the central hole 411 and an outer profile of the ring-shaped body 41 are provided with circular corner, respectively. A width of the vibration body 30 is greater than or equal to a width of the terminal fixing portion 10, and the width of the vibration body 30 is greater than or equal to a width of a coverage area of each connection arm 20, so as to improve the effect of removing the oxidation layer by vibration.

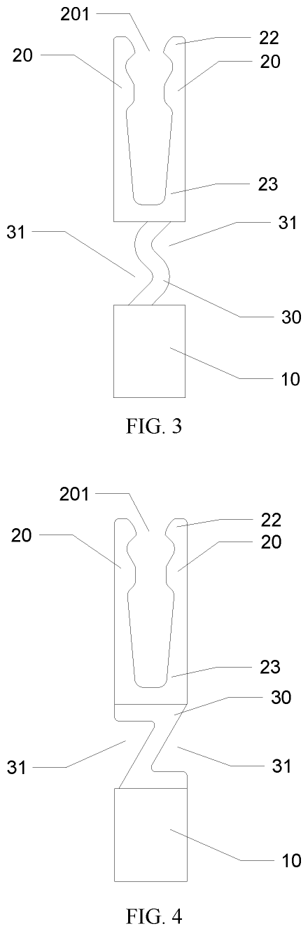

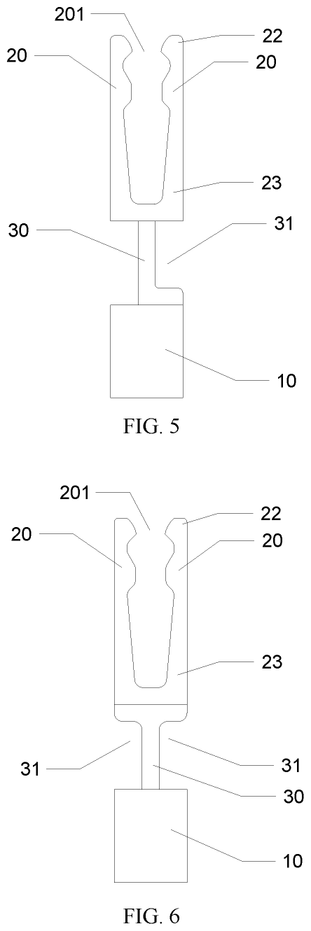

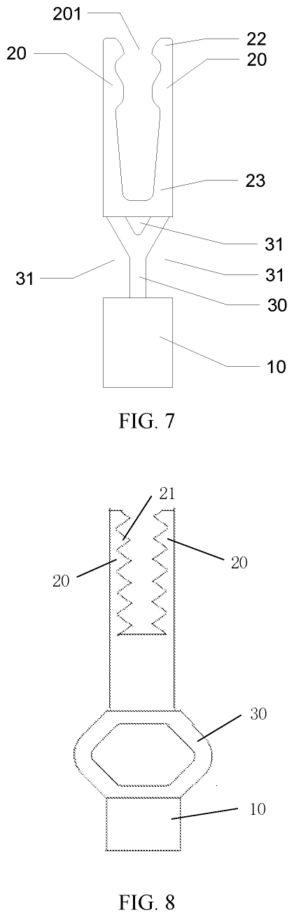

Further, the vibration body 30 is S-shaped, Z-shaped, U-shaped, V-shaped, L-shaped or T-shaped. As shown in FIG. 3, the vibration body 30 is S-shaped, and the recess 31 is provided at a side of the solid body of the vibration body 30. As shown in FIG. 4, the vibration body 30 is Z-shaped, and the recess 31 is provided at a side of the solid body of the vibration body 30. As shown in FIG. 5, the vibration body 30 is L-shaped, and the recess 31 is provided at a side of the solid body of the vibration body 30. As shown in FIG. 6, the vibration body 30 is T-shaped, and the recess 31 is provided at a side of the solid body of the vibration body 30. As shown in FIG. 7, the vibration body 30 is Y-shaped, and the recess 31 is provided at a side and in the middle of the solid body of the vibration body 30.

In an embodiment, an area of the recess is greater than 15% of a total area of the vibration body.

When the recess is a closed structure, as shown in FIGS. 1 and 2, the area of the recess is obvious, and an area of a hole through which the vibrating body 30 is punched is the area of the recess.

When the recess is a non-closed structure, as shown in FIGS. 3 to 6, an area of the vibration body 30 is the product of a maximum value of the vibration body 30 in a horizontal direction (the horizontal direction in FIG. 3) and the height of the vibration body 30 (a size in the vertical direction in FIG. 3), the area of the vibration body 30 minus an area of the solid body part of the vibration body 30 is the area of the recess.

When the recess simultaneously includes both closed and non-closed structures, as shown in FIG. 7, an area of the vibration body 30 is the product of a maximum value of the vibration body 30 in the horizontal direction and the height of the vibration body 30, the area of the vibration body 30 minus an area of the solid body part of the vibration body 30 is the area of the recess.

The recess 31 provided on the vibration body 30 can reduces stress, absorb energy during vibration, and improve the elastic deformation capacity of the vibration body 30. The deformation capacity is related to an occupation ratio of the area of the recess 31 to the whole area of the vibration body, the larger the occupation ratio, the stronger the deformation capacity. In order to verify the influence of the occupation ratio of the vibration body 30 on a vibration effect, the inventor conducts relevant tests, i.e., selecting micro-vibration terminals having vibration bodies with different proportions and selecting the same mating plug-in terminals, plugging them, and conducting a shaking test to observe whether a relative movement occurred between the connection arm 20 and the mating plug-in terminal.

In order to test the influence of different occupation ratios of the recess on a service life of the micro-vibration terminal, the inventor conducted a vibration experiment, a vibration mode adopted for the experiment may be sinusoidal vibration. The sinusoidal vibration is a test method often used in laboratories to simulate a vibration environment that occurs frequently in vehicles, such as rotation, pulsation, oscillation, etc. A damage of vibration to the micro-vibration terminal can generally be found in 30 minutes to an hour. The inventor selects 10 micro-vibration terminals having the recesses 31 with different proportions, and simultaneously places the micro-vibration terminals on a vibration device, the vibration frequency is 10 Hz, and observes whether the micro-vibration terminals are damaged during the experiment. The micro-vibration terminals that are damaged within 60 minutes are considered to be unqualified.

The above test result is shown in Table 1.

TABLE 1
Influence of occupation ratios of the recesses on deformation and service life of the micro-vibration terminals

| Proportion (%) | 10 | 13 | 15 | 20 | 30 | 35 | 40 | 45 | 50 | 55 | 60 | 65 | 70 | 75 | 80 | 85 | 90 |
|---|---|---|---|---|---|---|---|---|---|---|---|---|---|---|---|---|---|
| Whether a | No | No | Yes | Yes | Yes | Yes | Yes | Yes | Yes | Yes | Yes | Yes | Yes | Yes | Yes | Yes | Yes |
| movement | | | | | | | | | | | | | | | | | |
| occurs | | | | | | | | | | | | | | | | | |
| Whether a | Yes | Yes | No | No | No | No | No | No | No | No | No | No | No | No | No | No | No |
| deformation | | | | | | | | | | | | | | | | | |
| occurs | | | | | | | | | | | | | | | | | |
| Whether | Yes | Yes | No | No | No | No | No | No | No | No | No | No | No | No | No | No | No |
| there is a | | | | | | | | | | | | | | | | | |
| damage | | | | | | | | | | | | | | | | | |

As can be known from Table 1, when the occupation ratio of the area of the recess 31 is less than 15%, the connection arm 20 does not move relative to the mating plug-in terminal, which cannot achieve the purpose of removing an oxidation layer in a contact region, and since energy from vibration of the vibration device cannot be absorbed by the vibration body 30, the energy from the vibration will be directly transferred to the connection arm of the micro-vibration terminal, resulting in deformation and damage of the micro-vibration terminal. Therefore, the inventor selects a solution in which the area of the recess is greater than 15% of the total area of the vibration body, so as to avoid a situation in which the service life of the micro-vibration terminal cannot meet the requirements in some use environments where vibration is frequent.

In an embodiment, at least part of a surface of the micro-vibration terminal is provided with a plating layer, to improve corrosion resistance, improve conductive performance and increase number of times of plugging, the service life of the plug-in structure can be better prolonged. In an embodiment, a surface of the protrusion portion is provided with the plating layer, the plating layer on the surface of the protrusion portion is a first plating layer.

In an embodiment, a surface of the terminal fixing portion is provided with the plating layer, and the plating layer on the surface of the terminal fixing portion is a second plating layer.

In an embodiment, a surface of the connection arm exclusive of the protrusion portions and a surface of the vibration body are provided with the plating layer, and the plating layer on the surface of the vibration body is a third plating layer.

Further, a material of the first plating layer, a material of the second plating layer and a material of the third plating layer are different, i.e., in the first plating layer, the second plating layer and the third plating layer, a material of at least one of them is different from the others, i.e., a material of the second plating layer may be different from a material of the third plating layer, or a material of the first plating layer may be different from a material of the third plating layer, or a material of the first plating layer may be different from a material of the second plating layer.

Exemplarily, the material of the second plating layer and the material of the third plating layer are the same, the material of the first plating layer and the material of the second plating layer are different.

Further, a thickness of the first plating layer, a thickness of the second plating layer and a thickness of the third plating layer are different, i.e., in the first plating layer, the second plating layer and the third plating layer, a thickness of at least one of them is different from the others, i.e., a thickness of the second plating layer may be different from a thickness of the third plating layer, or a thickness of the first plating layer may be different from a thickness of the third plating layer, or a thickness of the first plating layer may be different from a thickness of the second plating layer.

Exemplarily, the thickness of the second plating layer and the thickness of the third plating layer are the same, the thickness of the first plating layer and the thickness of the second plating layer are different.

In an embodiment, the plating layer may be provided on the micro-vibration terminal by means of an electroplating, a chemical plating, a magnetron sputtering or a vacuum plating.

The electroplating method is a process of using the electrolysis principle to plate a thin layer of other metal or alloy on some metal surfaces.

The chemical plating method is a process of deposition of a metal by a controllable oxidation-reduction under a catalytic action of the metal.

The magnetron sputtering method is to use interaction of a magnetic field and an electric field to make electrons move spirally near a target surface, thus increasing a probability of electrons bombard argon to generate ions. The generated ions bombard the target surface under the action of the electric field so as to sputter a target material.

The vacuum plating method is to deposit various metal films and non-metal films on surfaces of parts by means of distillation or sputtering, etc. under a vacuum condition.

A material of the plating layer includes one or more selected from gold, silver, nickel, tin, tin-lead alloy, zinc, silver-antimony alloy, palladium, palladium-nickel alloy, graphite-silver, graphene-silver and silver-gold-zirconium alloy. Copper or aluminum as an active metal will oxidize with oxygen and water during use, hence one or more inactive metals are needed as a plating layer to prolong a service life of the terminal. In addition, for a metal contact that need to be plugging and unplugging frequently, a better wear-resistant metal is also needed as a plating layer, which can greatly prolong a service life of the contact. Contacts need good conductive performance, the electrical conductivity and stability of the above metals are better than copper or copper alloy, aluminum or aluminum alloy, which can make the terminal obtain better electrical performance and a longer service life.

In order to demonstrate the influence of different plating layer materials on the overall performance of the micro-vibration terminal, the inventor uses samples of the terminal with the same specification, the same material and different plating layer materials, and uses mating plug-in terminals with the same specification to do a series of tests on the number of times of plugging and unplugging and corrosion resistance time. An experiment result is shown in Table 2.

For the number of times of plugging and unplugging in the Table 2, the micro-vibration terminal and the mating plug-in terminal are fixed on an experiment bench respectively. a mechanical device is used to make the micro-vibration terminal and the mating plug-in terminal simulate plugging and unplugging. and after every 100 plugging and unplugging, it is necessary to stop to observe a damage situation of a plating layer on a surface of the connection arm 20. If the plating layer on the surface of the connection arm 20 is scratched and the material of the micro-vibration terminal is exposed, the experiment will be stopped and the number of times of plugging and unplugging at that time will be recorded. In this embodiment, it is unqualified if the number of times of plugging and unplugging is less than 8000.

For the corrosion resistance time test in the Table 2, the micro-vibration terminal is put into a salt spray test chamber, salt fog is sprayed to the connection arm 20, the connection arm is taken out and cleaned every 20 hours, the surface corrosion situation of the terminal is observed. i.e., a cycle, until the corrosion area of the surface of the connection arm 20 is greater than 10% of the total area, the test is stopped, and the number of cycles at that time is recorded. In this embodiment, it is unqualified if the number of cycles is less than 80.

TABLE 2
Influence of different plating layer materials on the number of times of plugging
and unplugging and corrosion resistance of the micro-vibration terminal
Different plating layer materials

| | | | | | | | | | | | |
|---|---|---|---|---|---|---|---|---|---|---|---|
| | | | | | | | | | | | silver- |
| | | | | tin- | | silver- | | palladium- | | | gold- |
| | | | | lead | | antimony | | nickel | graphite- | graphene- | zirconium |
| gold | silver | nickel | tin | alloy | zinc | alloy | palladium | alloy | silver | silver | alloy |

Number of times of plugging and unplugging

| | | | | | | | | | | | |
|---|---|---|---|---|---|---|---|---|---|---|---|
| 12500 | 11800 | 9500 | 9300 | 9800 | 9500 | 12200 | 12100 | 12400 | 12500 | 12000 | 11000 |

Number of cycles of corrosion resistance test

| | | | | | | | | | | | |
|---|---|---|---|---|---|---|---|---|---|---|---|
| 135 | 120 | 93 | 88 | 88 | 95 | 126 | 118 | 120 | 127 | 130 | 132 |

As can be seen from Table 2, when a material of the plating layer is selected to include gold, silver, silver-antimony alloy, palladium, palladium-nickel alloy, graphite-silver, graphene-silver and silver-gold-zirconium alloy, the experiment result exceeds the standard value more, and the performance is relatively stable. When a material of the plating layer is selected to include nickel, tin, tin-lead alloy and zinc, the experiment result can also meet the requirements, thus the inventor selects that the material of the plating layer includes one or more selected from gold, silver, nickel, tin, tin-lead alloy, zinc, silver-antimony alloy, palladium, palladium-nickel alloy, graphite-silver, graphene-silver and silver-gold-zirconium alloy.

In some embodiments, the plating layer includes a bottom layer and a surface layer, i.e., a multi-layer plating method is adopted for the plating layer. After the micro-vibration terminal is manufactured, there are still many slits and holes under the surface microscopic interface of the micro-vibration terminal, these slits and holes are the biggest reason for wear and corrosion of the micro-vibration terminal during use. Therefore, a bottom layer is firstly plated on the surface of the connection arm 20 to fill the slits and holes on the surface, so that the surface of the connection arm 20 is smooth and has no holes, then the surface layer is plated, which will be more firmly combined and flatter. There are no slits and holes on the surface of the plating layer, so that the wear resistance, corrosion resistance and electrical performance of the connection arm 20 are better, and the service life of the micro-vibration terminal is greatly prolonged.

In some embodiments, a material of the bottom layer includes one or more selected from gold, silver, nickel, tin, tin-lead alloy and zinc; a material of the surface layer includes one or more selected from gold, silver, nickel, tin, tin-lead alloy, silver-antimony alloy, palladium, palladium-nickel alloy, graphite-silver, graphene-silver and silver-gold-zirconium alloy.

In another embodiment, a thickness of the bottom layer is 0.01 μm to 15 μm. Exemplarily, the thickness of the bottom layer is 0.1 μm to 9 μm.

In another embodiment, a thickness of the surface layer is 0.5 μm to 55 μm. Exemplarily, the thickness of the surface layer is 1 μm to 35 μm.

In order to demonstrate the influence of a change in the thickness of the bottom layer of the plating layer on the overall performance of the micro-vibration terminal, the inventor uses samples of the connection arms with the same specification, the same material, the different thicknesses of nickel-plated bottom layer and the same thicknesses of silver-plated surface layer and uses a mating plug-in terminal with the same specification to do a series of temperature rise and corrosion resistance time tests, the experiment result is shown in Table 3.

In the temperature rise test in Table 3, the same current is conducted to the micro-vibration terminal and the mating plug-in terminal that are plugged with each other, temperatures of the connection arm 20 at the same position before the current is conducted and after the temperature is stable are detected in a closed environment, and take a difference therebetween to obtain an absolute value. In this embodiment, it is considered unqualified if a temperature rise is greater than 50K.

In the corrosion resistance time test in the Table 3, the micro-vibration terminal is put into a salt spray test chamber, salt fog is sprayed to each position of the connection arm 20, the connection arm is taken out and cleaned every 20 hours, the surface corrosion of the terminal is observed, i.e., a cycle, until the corrosion area of the surface of the connection arm 20 is greater than 10% of the total area, the test is stopped, and the number of cycles at that time is recorded. In this embodiment, it is unqualified if the number of cycles is less than 80.

TABLE 3
Influence of different thicknesses of bottom layer of plating layer on temperature
rise and corrosion resistance of the micro-vibration terminal
Different thicknesses of nickel-plated bottom layer (μm)

| | | | | | | | | | | | | | | | |
|---|---|---|---|---|---|---|---|---|---|---|---|---|---|---|---|
| 0.001 | 0.005 | 0.01 | 0.05 | 0.1 | 0.5 | 1 | 3 | 5 | 6 | 9 | 11 | 13 | 15 | 17 | 19 |

Temperature rise of the micro-vibration terminal (k)

| | | | | | | | | | | | | | | | |
|---|---|---|---|---|---|---|---|---|---|---|---|---|---|---|---|
| 10.8 | 12.2 | 14.6 | 16.5 | 18.3 | 21.3 | 24.2 | 26.7 | 28.7 | 31.2 | 35.7 | 40.5 | 43.6 | 47.5 | 58.3 | 67.3 |

Number of cycles of corrosion resistance test

| | | | | | | | | | | | | | | | |
|---|---|---|---|---|---|---|---|---|---|---|---|---|---|---|---|
| 69 | 78 | 83 | 94 | 103 | 108 | 113 | 117 | 121 | 124 | 127 | 129 | 130 | 131 | 129 | 127 |

As can be seen from Table 3, when a thickness of a nickel-plated bottom layer is less than 0.01 μm, although a temperature rise of the micro-vibration terminal is qualified, since the plating layer is too thin, the number of cycles of corrosion resistance of the connection arm 20 is less than 80, which does not meet the performance requirements on the terminal and has great influence on the overall performance and service life of a plug-in element, and in serious cases, the product service life will be sharply reduced, even a burning accident will occur in case of a failure. When a thickness of a nickel-plated bottom layer is greater than 15 μm, since the bottom layer of the plating layer is thicker, heat generated by the micro-vibration terminal fails to dissipate, so that a temperature rise of the terminal is not qualified, and the thicker plating layer is easy to fall off from a surface of the connection arm 20, resulting in a decrease in the number of cycles of corrosion resistance. Thus, the inventor selects that the thickness of the bottom layer of the plating layer is 0.01 μm to 15 μm. Exemplarily, the inventor found that when the thickness of the bottom layer of the plating layer is 0.1 μm to 9 μm, a comprehensive effect of the temperature rise and corrosion resistance of the terminal is better, therefore in order to further improve safety, reliability and practicality of the product itself, an exemplary thickness of the bottom layer of the plating layer is 0.1 μm to 9 μm.

In order to demonstrate the influence of a change in the thickness of the surface layer of the plating layer on the overall performance of the terminal, the inventor uses samples of the connection arms with the same specification, the same material, the same thickness of nickel-plated bottom layer and the different thicknesses of silver-plated surface layer and uses an mating plug-in element with the same specification to do a series of temperature rise and corrosion resistance time tests, the experiment result is shown in Table 4.

TABLE 4
Influence of different thicknesses of surface layer of plating layer on
temperature rise and corrosion resistance of the micro-vibration terminal
Different thicknesses of silver-plated surface layer (μm)

| | | | | | | | | | | | | | | | | |
|---|---|---|---|---|---|---|---|---|---|---|---|---|---|---|---|---|
| 0.1 | 0.5 | 1 | 1.5 | 5 | 10 | 15 | 20 | 25 | 30 | 35 | 40 | 45 | 50 | 55 | 60 | 65 |

Temperature rise of the micro-vibration terminal (k)

| | | | | | | | | | | | | | | | | |
|---|---|---|---|---|---|---|---|---|---|---|---|---|---|---|---|---|
| 11.3 | 13.6 | 15.1 | 17.3 | 21.3 | 23.4 | 25.5 | 28.1 | 31.1 | 35.2 | 38.3 | 42.9 | 45.2 | 48.0 | 49.9 | 53.3 | 69.5 |

Number of cycles of corrosion resistance test

| | | | | | | | | | | | | | | | | |
|---|---|---|---|---|---|---|---|---|---|---|---|---|---|---|---|---|
| 75 | 82 | 90 | 93 | 95 | 98 | 99 | 103 | 106 | 109 | 115 | 117 | 119 | 121 | 125 | 122 | 121 |

As can be seen from Table 4, when a thickness of a silver-plated surface layer is less than 0.5 μm, although a temperature rise of the terminal is qualified, since the plating layer is too thin, the number of cycles of corrosion resistance of the connection arm 20 is less than 80, which does not meet the performance requirements on the terminal and has great influence on the overall performance and service life of a mating plug-in structure, and in serious cases, the product service life will be sharply reduced, even a burning accident will occur in case of a failure. When the thickness of a silver-plated surface layer is greater than 55 μm, since the bottom layer of the plating layer is thicker, heat generated by the terminal fails to dissipate, so that a temperature rise of the terminal is not qualified, and the thicker plating layer is easy to fall off from a surface of the terminal, resulting in a decrease in the number of cycles of corrosion resistance. And, a metal of the surface layer of the plating layer is more expensive, so in case of using a thicker plating layer, the performance does not rise, there is no use value. Thus, the inventor selects that the thickness of the silver-plated surface layer is 0.5 μm to 55 μm. Exemplarily, the inventor found that when the thickness of the surface layer of the plating layer is 1 μm to 35 μm, a comprehensive effect of the temperature rise and corrosion resistance of the terminal is better, therefore in order to further improve safety, reliability and practicality of the product itself, an exemplary thickness of the surface layer of the plating layer is 1 μm to 35 μm.

In some embodiments, a plating layer is provided on the terminal fixing portion 10, so as to improve corrosion resistance, improve conductive performance, facilitate welding connection with a cable, and better prolong the service life of the terminal fixing portion 10. The plating layer may cover the surface of the entire terminal fixing portion 10, and may also be only provided on part of an area of the terminal fixing portion 10.

A material of the plating layer of the terminal fixing portion 10 is different from that a material of the plating layer of the connection arm 20. As can be known from the above description, plating layers with different metals have different conductive effects and corrosion resistance, plating layers with a metal of higher price have a better conductive effect and corrosion resistance, can be plugged and unplugged for more times, and are used in a more complex environment and obtain a longer service life, however due to the higher price, use of these metals as plating layers is limited. Therefore, the inventor will use gold, silver, silver-antimony alloy, graphite-silver, graphene-silver, palladium-nickel alloy, tin-lead alloy or silver-gold-zirconium alloy with excellent performance but higher price as the material of plating layer in a position subjected to frequent plugging and unplugging and exposed to a use environment such as connection arm 20. The terminal fixing portion 10 is a position for connecting a wire, there is no relative displacement after connecting with the wire, and the terminal fixing portion 10 is generally protected inside a molded housing and will not be exposed to a use environment, hence the inventor will use commonly used metals i.e., tin, nickel, zinc as the material of plating layer of the terminal fixing portion 10 to reduce the cost of the micro-vibration terminal.

A thickness of the plating layer of the terminal fixing portion 10 is different from that a thickness of the plating layer of the connection arm 20. As can be known from the above description, the connection arm 20 is plugged and unplugged many times, and will be exposed to a use environment, a plating layer will be scratched and corroded in an external environment. If a thickness of the plating layer is thinner, it will be easily scratched or corroded during use, so the inventor sets a thicker plating layer at the position of the connection arm 20 to increase scratch resistance and corrosion resistance of a plug-in end. Moreover, at a side of the terminal fixing portion 10, since there is no scratching and no exposure to the use environment, a plating layer with a lower thickness can be used, thereby reducing the cost.

In some embodiments, a plating layer is provided on the vibration body 30. Further, a material of the plating layer of the vibration body 30, a material of the plating layer of the terminal fixing portion 10 and a material of the plating layer of the connection arm 20 are different from each other. As can be known from the above description, plating layers with different metals have different conductive effects and corrosion resistance, plating layers with a higher price metal have a better conductive effect and corrosion resistance, can be plugged and unplugged for more times, and are used in a more complex environment and obtain a longer service life, however due to the higher price, use of these metal as plating layers is limited. Therefore, the inventor uses metal materials such as gold, silver, silver-antimony alloy, graphite-silver, graphene-silver, palladium-nickel alloy, tin-lead alloy or silver-gold-zirconium alloy with excellent performance but a higher price as the material of plating layer at a position subjected to frequent plugging and unplugging or exposed to a use environment, on the contrary, in some positions with fewer times of plugging and fewer times of unplugging and unlike to be exposed, a material with a lower price is selected as the material of the plating layer.

In some exemplary embodiments, a thickness of the plating layer of the vibration body, a thickness of the plating layer of the terminal fixing portion and a thickness of the plating layer of the connection arm are different from each other. As can be known from the above description, a part of the area of the micro-vibration terminal is plugged and unplugged frequently, and will be exposed to a use environment, a plating layer will be scratched and corroded in an external environment. If a thickness of the plating layer is thinner, it will be easily scratched or corroded during use, so the inventor sets a thicker plating layer at these positions to increase scratch resistance and corrosion resistance of a plug-in end. Meanwhile, in other regions, since there is no scratching and no exposure to the use environment, a plating layer with a lower thickness can be used, thereby reducing the cost.

In some embodiments, a body material of the micro-vibration terminal is tellurium-copper alloy, the tellurium-copper alloy may make the terminal have good conductive performance and easy-cutting performance, ensures the electrical performance and can also improve processability, and meanwhile, the elasticity of the tellurium-copper alloy is also very excellent.

Exemplarily, in the tellurium-copper alloy; a content of tellurium is 0.1% to 5%, and further exemplarily, in the tellurium-copper alloy, the content of tellurium is 0.2% to 1.2%.

In order to test the influence of the tellurium content on conductivity of the terminal, the inventor selects 10 plug-in terminals with the same shape and with extendable and contractible seams of the same width for testing, all terminals include tellurium-copper alloy, of which the contents of tellurium are 0.05%, 0.1%, 0.2%, 1%, 1.2%, 1.8%, 3%, 5%, 6%, 7%, respectively. A test result is shown in Table 5.

TABLE 5
Influence of tellurium-copper alloy with different tellurium contents on electrical conductivity

| | | | | | | | | | | |
|---|---|---|---|---|---|---|---|---|---|---|
| Tellurium | 0.05% | 0.1% | 0.2% | 1% | 1.2% | 1.8% | 3% | 5% | 6% | 7% |
| content | | | | | | | | | | |
| Electrical | 98.8% | 99.4% | 99.6% | 99.7% | 99.8% | 99.6% | 99.3% | 99.1% | 98.7% | 98.5% |
| conductivity | | | | | | | | | | |

As can be known from Table 5, when the content of tellurium is less than 0.1% or greater than 5%, the electrical conductivity decreases significantly and cannot meet an actual demand. When the content of tellurium is greater than or equal to 0.2% and less than or equal to 1.2%, the conductive performance is the best, so the inventor selects tellurium-copper alloy with the content of tellurium being 0.1% to 5%. In the most ideal case, the tellurium-copper alloy with a content of 0.2% to 1.2% is selected.

In some embodiments, the body material of the micro-vibration terminal includes

beryllium.

Further, a content of beryllium in the body material of the micro-vibration terminal is 0.05% to 5%.

Further, the content of beryllium in the body material of the micro-vibration terminal is 0.1% to 3.5%.

The micro-vibration terminal includes beryllium, which may make the terminal have good conductive performance and easy-cutting performance, ensures the electrical performance and can also improve processability and meanwhile, can ensure that elasticity is also excellent.

In order to test the influence of the beryllium content on conductivity of the terminal, the inventor selects 10 micro-vibration terminals with the same shape and with extendable and contractible seams of the same width for testing, all terminals include beryllium, the contents of which are 0.03%, 0.05%, 0.1%, 0.2%, 1%, 1.2%, 1.8%, 3%, 3.5%, 5%, 6%, respectively. A test result is shown in Table 6.

As can be known from Table 6, when the content of beryllium is less than 0.05% or greater than 5%, the electrical conductivity decreases significantly and cannot meet an actual demand. When the content of beryllium is greater than or equal to 0.1% and less than or equal to 3.5%, the conductive performance is the best, so the inventor selects a micro-vibration terminal with the content of beryllium being 0.1% to 5%. In the most ideal case, the micro-vibration terminal with a content of beryllium being 0.1% to 3.5% is selected.

TABLE 6
Influence of different beryllium contents on electrical conductivity:

| | | | | | | | | | | | |
|---|---|---|---|---|---|---|---|---|---|---|---|
| Beryllium | 0.03% | 0.05% | 0.1% | 0.2% | 1% | 1.2% | 1.8% | 3% | 3.5% | 5% | 6% |
| content | | | | | | | | | | | |
| Electrical | 98.9% | 99.2% | 99.5% | 99.6% | 99.8% | 99.8% | 99.6% | 99.3% | 99.3% | 99.1% | 98.7% |
| conductivity | | | | | | | | | | | |

In an exemplary embodiment, the terminal fixing portion 10 is flat plate-shaped or barrel-shaped or U-shaped or V-shaped or bowl-shaped. In some exemplary embodiments, the terminal fixing portion 10 is bowl-shaped, as shown in FIG. 12, to facilitate full contact with a cable. Similarly, the terminal fixing portion 10 may further be selected to be flat plate-shaped or barrel-shaped or U-shaped or V-shaped.

In an exemplary embodiment, the terminal fixing portion 10 is crimped or welded with a conductor of the cable.

Crimping is a production process in which the terminal fixing portion 10 and the conductor of the cable are assembled and then stamped into a whole by a crimping machine. The advantage of the crimping is mass production, a product with stable quality can be manufactured in large amounts by using an interlocking terminal and an automatic crimping machine.

For welding, friction welding, resistance welding, ultrasonic welding, arc welding, pressure welding, laser welding or explosion welding is used to melt the terminal fixing portion 10 and the conductor of the cable into a whole through a metal welding spot, so a connection is firm and a contact resistance is small.

### Solution 2

The present disclosure further includes a plug-in structure, including the micro-vibration terminal, and further including a mating plug-in terminal, a plurality of micro-vibration terminals are connected through the terminal fixing portion, and the mating plug-in terminal are plugged with the plurality of the micro-vibration terminals.

The micro-vibration terminal is applied to an equipment such as an automobile, etc., the vibration body 30 drives the connection arm 20 to vibrate together, resulting in a relative motion between the connection arm 20 and the mating plug-in terminal and resulting in repeated friction. Through friction, an oxidation layer on a surface of the contact area between the mating plug-in terminal and the overhanging end 22 is removed, and a risk of oxidation corrosion of the micro-vibration terminal and the mating plug-in terminal is reduced. The recess 31 may reduce a stress, absorb energy during vibration, enhance an elastic deformation capacity of the vibration body 30, improve an effect of removing an oxidation layer by friction, and avoid the fretting corrosion problem caused by a displacement of the overhanging end 22 due to vibration. The micro-vibration terminal is applied in the field of electrical connection, which may automatically remove an oxidation layer on a surface of a terminal, reduce oxidation corrosion and prolong a service life.

Exemplarily, a range of a plugging force between a single micro-vibration terminal and the mating plug-in terminal is 3N to 150N. More exemplarily, a range of a plugging force between a single micro-vibration terminal and the mating plug-in terminal is 10N to 95N.

In order to test the influence of a plugging force on electrical conductivity, the inventor selects 10 pairs of different micro-vibration terminals having the same shape to perform a plugging force test with a mating plug-in terminal, the test result is shown in Table 7.

TABLE 7
Influence of different plugging forces on electrical conductivity

| | | | | | | | | | | |
|---|---|---|---|---|---|---|---|---|---|---|
| Plugging | 2 | 3 | 10 | 20 | 40 | 70 | 95 | 100 | 150 | 155 |
| force (N) | | | | | | | | | | |
| Electrical | 99.2% | 99.5% | 99.6% | 99.6% | 99.7% | 99.8% | 99.9% | 99.9% | 99.92% | 99.92% |
| conductivity | | | | | | | | | | |

As can be known from Table 7, when the plugging force is less than 3N, the electrical conductivity decreases significantly and cannot meet an actual demand. When the plugging force is greater than or equal to 3N, the conductive performance is good, while when the plugging force is greater than 150N, the conductive performance is also excellent. However, after the plugging force is greater than 150N, an increase of the electrical conductivity is not obvious, and the processing is difficult, so the inventor considered that an exemplary connection force is 3N to 150N. Similarly, as can be known from Table 7, when the plugging force is greater than or equal to 10N, the conductive effect is better, while when the plugging force is greater than 95N, an increase of the electrical conductivity is not obvious, so the inventor further considered that an exemplary plugging force is 10N to 95N.

Exemplarily, a contact resistance between the mating plug-in terminal and each micro-vibration terminal is less than 9 mΩ.

Generally, a larger current need to be conducted. If a contact resistance between the micro-vibration terminal and the mating plug-in terminal is greater than 9 mΩ, a larger temperature rise will be produced at a contact position, and the temperature will become higher and higher with the increase of time. Due to differences in material and thermal expansion rate between the micro-vibration terminal and the mating plug-in terminal, mechanical deformation is not synchronized, resulting in an internal stress, which will cause a plating layer to fall off in serious cases and cannot achieve the role of protection. Meanwhile, a too high temperature of the micro-vibration terminal and the mating plug-in terminal may be transmitted to an insulation layer of a wire connected therewith, so that the insulation layer is melt and cannot realize insulation protection, and in severe cases, a short circuit may be caused, resulting in a damage to a connection structure, even burning and other safety accidents. Therefore, the inventor set a contact resistance between the micro-vibration terminal and the mating plug-in terminal to be less than 9 mΩ.

In order to verify the influence of a contact resistance between the mating plug-in terminal and the micro-vibration terminal on a temperature rise and the electrical conductivity of the plug-in structure, the inventor selects the micro-vibration terminal with different contact resistances and the same mating plug-in terminals, and tests the electrical conductivity and the temperature rise.

The electrical conductivity test is to detect corresponding electrical conductivity at a plugging position after the mating plug-in terminal is plugged into the micro-vibration terminal and the current is conducted in the plug-in structure. In this embodiment, the electrical conductivity greater than 99% is an ideal value.

The temperature rise test is to conduct the same currents to the plug-in structure, and detect temperatures of the micro-vibration terminal at the same position before the current conduction and after the temperature is stable in a closed environment, and take an absolute value of the differences. In this embodiment, it is considered unqualified if a temperature rise is greater than 50K.

TABLE 8
Influence of different contact resistances between the mating plug-in terminal and
the micro-vibration terminal on electrical conductivity and temperature rise
Different contact resistances between the mating plug-in terminal and the micro-vibration terminal (mΩ)

| | | | | | | | | |
|---|---|---|---|---|---|---|---|---|
| 10 | 9 | 8 | 6 | 4 | 3 | 2 | 1 | 0.5 |

temperature rise (k) of the plug-in structure

| | | | | | | | | |
|---|---|---|---|---|---|---|---|---|
| 55 | 48 | 41 | 35 | 29 | 23 | 18 | 14 | 7 |

electrical conductivity (%) of the plug-in structure

| | | | | | | | | |
|---|---|---|---|---|---|---|---|---|
| 98.8 | 99.3 | 99.5 | 99.6 | 99.7 | 99.7 | 99.8 | 99.9 | 99.9 |

As can be seen from Table 8, when the contact resistance between the mating plug-in terminal and the micro-vibration terminal is greater than 9 mΩ, the temperature rise of the plug-in structure is greater than 50K, meanwhile the electrical conductivity of the plug-in structure is less than 99%, which does not meet the standard requirements. Therefore, the inventor set the contact resistance between the mating plug-in terminal and micro-vibration terminal is less than 9 mΩ.

### Solution 3

The present disclosure further provides a motor vehicle, including the micro-vibration terminal.

### Solution 4

The present disclosure further provides another motor vehicle, including the plug-in structure.

The above contents are only schematic embodiments of the present disclosure and are not intended to limit the scope of the present disclosure. An equivalent change and amendment made by any person skilled in the art without deviating from the idea and principle of the present disclosure should fall into the scope protected by the present disclosure.

1. A micro-vibration terminal, comprising a terminal fixing portion, a vibration body and a connection arm, all of which are disposed sequentially, wherein:
the vibration body is fixedly connected to the terminal fixing portion, and the terminal fixing portion is used for being electrically connected to a cable;
the connection arm comprises an overhanging end and a fixed end, the fixed end is fixedly connected to the vibration body, and the overhanging end is used for being in contact fit with a mating plug-in terminal; and
the vibration body is provided with a recess.

2. The micro-vibration terminal according to claim 1, wherein:
the micro-vibration terminal comprises at least two connection arms, the fixed end of each connection arm being fixedly connected to the vibration body,
a plugging groove is provided between two opposite overhanging ends, and
the mating plug-in terminal is capable of being plugged into the plugging groove and in contact fit with the overhanging ends.

3. The micro-vibration terminal according to claim 1, wherein an inner side of the connection arm is provided with a plurality of protrusion portions distributed at intervals in an extension direction of the overhanging end.

4. (canceled)

5. The micro-vibration terminal according to claim 3, wherein cross-sectional shapes of the plurality of protrusion portions of the same overhanging end are different.

6-8. (canceled)

9. The micro-vibration terminal according to claim 1, wherein an area of the recess is greater than 15% of a total area of the vibration body.

10. The micro-vibration terminal according to claim 3, wherein:
at least part of a surface of the micro-vibration terminal is provided with a plating layer, a surface of the protrusion portion is provided with the plating layer, and the plating layer on the surface of the protrusion portion is a first plating layer;
a surface of the terminal fixing portion is provided with the plating layer, and the plating layer on the surface of the terminal fixing portion is a second plating layer; and
a surface of the connection arm exclusive of the protrusion portions and a surface of the vibration body are provided with the plating layer, and the plating layer on the surface of the vibration body is a third plating layer.

11-12. (canceled)

13. The micro-vibration terminal according to claim 10, wherein a material of the first plating layer, a material of the second plating layer, and a material of the third plating layer are different.

14. (canceled)

15. The micro-vibration terminal according to claim 10, wherein a thickness of the first plating layer, a thickness of the second plating layer, and a thickness of the third plating layer are different.

16-17. (canceled)

18. The micro-vibration terminal according to claim 3, wherein:
at least part of a surface of the micro-vibration terminal is provided with a plating layer, a surface of the protrusion portion is provided with the plating layer, and the plating layer on the surface of the protrusion portion is a first plating layer; and
the plating layer comprises a bottom layer and a surface layer.

19-20. (canceled)

21. The micro-vibration terminal according to claim 18, wherein a thickness of the bottom layer is 0.01 μm to 15 μm.

22. (canceled)

23. The micro-vibration terminal according to claim 18, wherein a thickness of the surface layer is 0.5 μm to 55 μm.

24. (canceled)

25. The micro-vibration terminal according to claim 1, wherein a body material of the micro-vibration terminal is tellurium-copper alloy.

26. The micro-vibration terminal according to claim 25, wherein a content of tellurium in the body material of the micro-vibration terminal is 0.1% to 5%.

27. The micro-vibration terminal according to claim 1, wherein a body material of the micro-vibration terminal comprises beryllium.

28. The micro-vibration terminal according to claim 27, wherein a content of beryllium in the body material of the micro-vibration terminal is 0.05% to 5%.

29-30. (canceled)

31. The micro-vibration terminal according to claim 1, wherein the terminal fixing portion is crimped or welded with a conductor of the cable.

32. A plug-in structure comprising the micro-vibration terminal according to claim 1, further comprising a mating plug-in terminal, wherein a plurality of micro-vibration terminals are connected through the terminal fixing portion, and the mating plug-in terminal are plugged with the plurality of the micro-vibration terminals.

33. The plug-in structure according to claim 32, wherein a range of a plugging force between a single micro-vibration terminal and the mating plug-in terminal is 3N to 150N.

34. (canceled)

35. The plug-in structure according to claim 32, wherein a contact resistance between the single micro-vibration terminal and the mating plug-in terminal is less than 9 mΩ.

36. A motor vehicle comprising the micro-vibration terminal according to claim 1.

37. (canceled)
